(19) United States
(12) Patent Application Publication
(10) Pub. No.: US 2024/0106043 A1
(43) Pub. Date: Mar. 28, 2024

(54) Pouch-Type Secondary Battery

(71) Applicant: LG Energy Solution, Ltd., Seoul (KR)

(72) Inventors: Hyun Jin Kim, Daejeon (KR); Chang Ho Kim, Daejeon (KR); Seon Uk Kim, Daejeon (KR); Jae Min Kim, Daejeon (KR)

(73) Assignee: LG Energy Solution, Ltd., Seoul (KR)

(21) Appl. No.: 18/371,864

(22) Filed: Sep. 22, 2023

(30) Foreign Application Priority Data
Sep. 23, 2022 (KR) 10-2022-0121205

(51) Int. Cl. H01M 50/184; H01M 50/105; H01M 50/188; H01M 50/317

(52) U.S. Cl. CPC H01M 50/184; H01M 50/105; H01M 50/188; H01M 50/317; H01M 50/178

(57) ABSTRACT

Provided is a pouch secondary battery. The pouch-type secondary battery may include an electrode assembly and a pouch-type battery case. The pouch-type battery case may include a cup part configured to accommodate the electrode assembly, a pair of first sealing parts disposed at both sides of the cup part perpendicular to a length direction, and a second sealing part configured to connect the pair of first sealing parts to each other and disposed at one side of the cup part perpendicular to a width direction. When an area of the first sealing part is A mm2, and a weight of the electrode assembly is B g, a ratio A/B may be about 0.29 or more.

### CROSS-REFERENCE TO RELATED APPLICATIONS

This application claims the priority of Korean Patent Application No. 10-2022-0121205 filed on Sep. 23, 2022, in the Korean Intellectual Property Office, the disclosure of which is incorporated herein by reference.

### BACKGROUND OF THE INVENTION

### Field of the Invention

The present invention relates to a pouch-type secondary battery, and more particularly, to a pouch-type secondary battery having excellent impact resistance.

### Description of the Related Art

Lithium secondary batteries are often manufactured by applying electrode active material slurry to positive electrode collectors and negative electrode collectors to manufacture positive electrodes and negative electrodes. The positive electrodes and the negative electrodes are then stacked on both sides of a separator to form an electrode assembly. Next, the electrode assembly is accommodated in a case, and an electrolyte is injected into the case.

Traditionally, secondary batteries have been classified according to a shape of the case accommodating the electrode assembly. Example secondary batteries include pouch-type secondary batteries, can-type secondary batteries, and prismatic-type secondary batteries. For example, pouch-type secondary batteries are manufactured by pressing a flexible pouch film to form a cup part into which an electrode assembly is accommodated, before the pouch is sealed and an electrolyte is injected. Can-type secondaries, on the other hand, are manufactured by accommodating an electrode assembly into a can made of a metal material provided with a top cap to seal the can, and injecting an electrolyte material into the sealed can.

While pouch-type secondary batteries are light weight, exhibit excellent space utilization, and have high energy densities due to their stacked electrode assemblies, they are more vulnerable to fire, explosion, and electrolyte leakage upon external impact compared to can-type secondary batteries.

Secondary batteries are used in a wide variety of products including electric vehicles to reduce and/or prevent greenhouse gas emissions. When secondary batteries are used in electric vehicles, such batteries are required to have excellent safety to protect passengers. Therefore, there is a desire to improve impact resistance of pouch-type secondary batteries.

### SUMMARY

An aspect of the present disclosure provides a pouch-type secondary battery in which, when an external impact is applied, separation of an electrode assembly and/or leakage of an electrolyte is/are suppressed.

According to an aspect of the present disclosure, there is provided a pouch-type secondary battery including: an electrode assembly; and a pouch-type battery case. The pouch-type battery case may include a cup part configured to accommodate the electrode assembly, a pair of first sealing parts disposed at both sides of the cup part in a length direction, respectively, and a second sealing part connecting the pair of first sealing parts to each other and disposed at least on one side of the cup part in a width direction. When an area of the first sealing part is A mm2, and a weight of the electrode assembly is B g, a ratio A/B may be about 0.29 or more.

The ratio A/B may be about 0.37 or less.

The pouch-type battery case may further include a gas pocket part disposed between the cup part and at least one of the pair of first sealing parts.

A minimum distance between the first sealing part and the electrode assembly in the length direction of the cup part may range between about 0.5% and about 0.8% compared to a length of the electrode assembly.

The first sealing part may include: a first section having a first end connected to the second sealing part and a second end, and a distance between the first section and the cup part in the length direction of the cup part may increase from the first end to the second end; and a second section connected to the first section and from which an electrode lead connected to the electrode assembly protrudes.

A minimum distance between the first section and the electrode assembly in the length direction of the cup part may range between about 0.5% and about 0.8% of a length of the electrode assembly.

The pouch-type battery case may further include a folding part disposed at an opposite side of the second sealing part with respect to the cup part and connects the pair of first sealing parts to each other. Each of the first sealing parts may further include a third section having an end connected to the second section and an opposite end connected to the folding part, and a distance between the third section and the cup part in the length direction of the cup part increases from the opposite end connected to the folding part to the end connected to the second section.

A minimum distance between the first section and the electrode assembly in the length direction of the cup part may be less than a minimum distance between the third section and the electrode assembly.

The first section may have a length greater than a length of the third section.

According to another aspect of the present disclosure, there is provided a pouch-type secondary battery including: an electrode assembly; and a pouch-type battery case. The pouch-type battery case may include a cup part configured to accommodate the electrode assembly, a pair of first sealing parts disposed at both sides of the cup part in a length direction, respectively, and a second sealing part connecting the pair of first sealing parts to each other and disposed at least on one side of the cup part in a width direction. A minimum distance between the first sealing part and the electrode assembly in the length direction of the cup part may be about 0.5% or more compared to a length of the electrode assembly.

The minimum distance between the first sealing part and the electrode assembly in the length direction of the cup part may be about 0.8% or less compared to a length of the electrode assembly.

When an area of the first sealing part is A mm2, and a weight of the electrode assembly is B g, a ratio A/B may range of about 0.29 to about 0.37.

The pouch-type secondary battery case may further include a gas pocket part disposed between the cup part and at least one of the pair of first sealing parts.

According to yet another aspect of the present disclosure, there is provided a pouch-type secondary battery for reducing greenhouse gas emissions including: an electrode assembly; and a pouch-type battery case. The pouch-type battery case may include a cup part configured to accommodate the electrode assembly, a pair of first sealing parts disposed at both sides of the cup part in a length direction, respectively, a second sealing part connecting the pair of first sealing parts to each other and disposed at least on one side of the cup part in a width direction, and a gas pocket part disposed between the cup part and at least one of the pair of first sealing parts. The first sealing part may include a first section defining an obliquely curved length between the second sealing part and a second section.

The pouch-type battery case may further include a folding part disposed at an opposite side of the second sealing part with respect to the cup part, the folding part connecting the pair of first sealing parts to each other.

The first sealing part may further include a third section defining an obliquely curved length between the folding part and the second section.

When an area of the first sealing part is A mm2, and a weight of the electrode assembly is B g, a ratio A/B may be between about 0.29 and about 0.37.

The pouch-type battery case may further include a sub-sealing part disposed on or adjacent to the folding part and between the third section and the cup part.

A minimum distance between the first section of the first sealing part and the electrode assembly in the length direction of the cup part may be between about 0.5% and about 0.8% compared to a length of the electrode assembly.

The minimum distance may be a distance between the cup part and an end of the first section of the first sealing part connected to the second sealing part.

### BRIEF DESCRIPTION OF THE DRAWINGS

The above and other aspects, features, and advantages of the present disclosure will be more clearly understood from the following detailed description taken in conjunction with the accompanying drawings, in which:

FIG. 1 is an exploded view of a pouch-type secondary battery according to an embodiment of the present disclosure;

FIG. 2 is a plan view of the pouch-type secondary battery of FIG. 1; and

FIG. 3 is a partial enlarged plan view of a pouch-type secondary battery according of FIG. 2.

### DETAILED DESCRIPTION OF THE PREFERRED EMBODIMENT

Hereinafter, aspects of the present disclosure will be described in detail with reference to the accompanying drawings so that those of ordinary skill in the art can easily carry out the present disclosure. However, the disclosure may be implemented in several different forms and is not limited or restricted by the following examples.

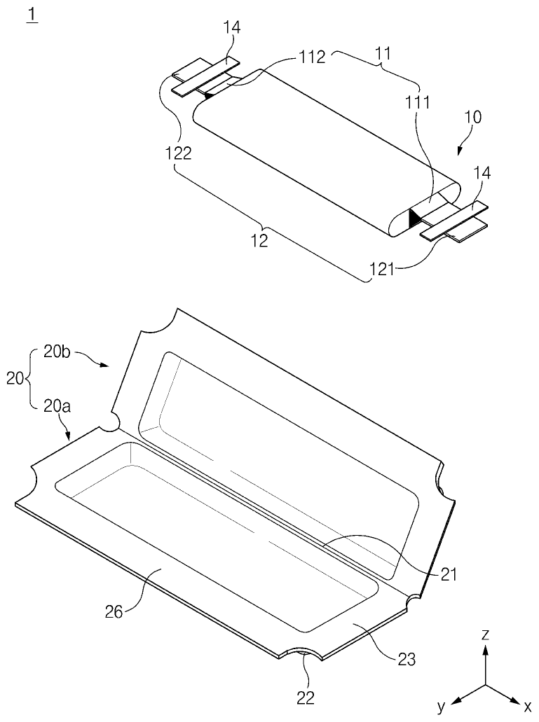

FIG. 1 is an exploded view of a pouch-type secondary battery 1 according to an embodiment of the present disclosure.

Pouch-type secondary battery 1 may include an electrode assembly 10 and a pouch-type battery case 20 (hereinafter, referred to as a ‘battery case’).

The electrode assembly 10, as shown in FIG. 1, may be provided by alternately stacking a positive electrode and a negative electrode with a separator therebetween. That is, the electrode assembly 10 may include a plurality of electrodes and a separator disposed between the plurality of electrodes to insulate the plurality of electrodes from each other. Alternatively, electrode assembly 10 may be a jelly-roll type, a stack and folding type, or the like. Electrode assembly 10 may then be accommodated together with an electrolyte in a cup part 22 of the battery case 20.

The electrode assembly 10 may include a plurality of electrode tabs 11. Each electrode tab 11 may be connected to the positive electrode and the negative electrode and protrude outward from the electrode assembly 10, thereby serving as a path, through which electrons move, between the inside and outside of the electrode assembly 10.

The electrode tabs 11 may be formed by cutting a non-coating portion or by connecting a separate conductive member to the non-coating portion through ultrasonic welding.

The plurality of electrode tabs 11 may include positive electrode tabs 111 connected to the positive electrodes and negative electrode tabs 112 connected to the negative electrodes. Although FIG. 1 illustrates the positive electrode tabs 111 and the negative electrode tabs 112 protruding in opposite directions of the electrode assembly 10, respectively, the present disclosure is not limited thereto. For example, the positive electrode tabs 111 and the negative electrode tabs 112 may protrude, for example, in parallel to each other from one side of electrode assembly 10 in the same direction.

An electrode lead 12 that supplies electricity to the outside of the secondary battery 1 may be connected to the electrode tabs 11 of electrode assembly 10 through spot welding or the like. In addition, a portion of the electrode lead 12 may be surrounded by an insulating part 14. The insulating part 14 may be confined to terrace parts 23 and 26 of battery case 20 and, more specifically, to terrace parts 23 and 26 to which the first case 20a and the second case 20b of the battery case 20 are thermally fused. Therefore, the insulating part 14 may insulate the electrode lead 12 from the battery case 20 and maintain the sealing of the battery case 20. Although insulating part 14 is generally formed by a relatively-thin insulation tape which may easily be attached to the electrode lead 12, the present disclosure is not limited thereto. For example, other materials may be used as the insulating part 14 as long as the materials are capable of insulating the electrode lead 12.

The electrode lead 12 may have one end connected to the electrode tabs 11 and the other end protruding to the outside of the battery case 20. The electrode lead 12 may include a positive electrode lead 121 connected to the positive electrode tabs 111 and a negative electrode lead 122 connected to the negative electrode tabs 112.

In this regard, the electrode lead 12 may electrically connect the electrode assembly 10 to electrical components outside of battery case 20. Also, since each of the positive electrode tabs 111 and the negative electrode tab 112s are formed to protrude in various directions, the positive electrode lead 121 and the negative electrode lead 122 may extend in various directions, for example, from opposite sides of battery case 20 and in opposite directions, or from one side of the battery case in the same direction.

The battery case 20 may accommodate the electrode assembly 10 therein and may be formed by molding a laminate sheet. In more detail, when the laminate sheet having flexibility is drawn and molded using a die and a punch, a portion of the battery case 20 may be stretched to form a cup part 22 having a pocket-shaped accommodation space.

The electrode assembly 10 may be accommodated in the cup part 22 of the battery case 20 so that a portion of the electrode lead 12 is exposed and then the battery case 20 may be sealed. In one example, the battery case 20 may include a pair of cases 20a and 20a, more specifically, a first case 20a and a second case 20b.

The first case 20a and the second case 20b may be connected to each other by a folding part 21. However, the present disclosure is not limited thereto. For example, it is also possible to manufacture the first case 20a and the second case 20b separately, and then seal the first case 20a and the second case 20b together after accommodating the electrode assembly 10 therein.

The cup part 22 may be provided in at least one of the pair of cases 20a and 20b to provide an accommodation space capable of accommodating the electrode assembly 10. The cup part 22 may have a recessed shape.

Hereinafter, a case in which the cup part 22 is provided in each of the cases 20a and 20b will be described. However, those skilled in the art will appreciate that the cup part 22 may be provided only in one of the pair of cases 20a and 20b.

The cup parts 22 in each of the pair of cases 20a and 20b may be disposed to face each other and may accommodate the electrode assembly 10. When compared to the instances in which the cup part 22 is provided only in one of the pair of cases 20a and 20b, the battery case 20 may accommodate an electrode assembly 10 having an increased thickness and, in turn, a larger capacity.

The first case 20a and the second case 20b may be connected to each other by the folding part 21. When the cup part 22 is provided in each of the cases 20a and 20b, a portion of the folding part 21 may be disposed between the cup part 22 of the first case 20a and the cup part 22 of the second case 20b, and the other portion of the folding part 21 may be disposed between a first terrace part 23 of the first case 20a and a first terrace part 23 of the second case 20b. The first terrace part 23 will be described later.

The folding part 21 may extend parallel to a length direction (e.g., a direction parallel to an X axis shown in FIGS. 1-3) of the electrode assembly 10. When the folding part 21 is folded, the first case 20a and the second case 20b may face each other.

The cases 20a and 20b may include the terrace parts 23 and 26 disposed around the cup part 22, respectively. In more detail, the terrace parts 23 and 26 may include a pair of first terrace parts 23 disposed at both sides of the cup part 22 in a longitudinal direction (e.g., the direction parallel to the X axis), and a second terrace part 26 connecting the pair of first terrace parts 23 to each other and disposed at one side of the cup part 22 in a width direction (e.g., a direction parallel to a Y axis).

The second terrace part 26 may be disposed at an opposite side of the folding part 21 with respect to the cup part 22. If the first case 20a and the second case 20b are separately manufactured and not connected to each other by the folding part 21, the second terrace part 26 may be disposed at both sides of the cup part 22 in the width direction.

When the folding part 21 is folded, the terrace parts 23 and 26 of the first case 20a and the second case 20b may be in contact with each other. Here, the insulating part 14 of the electrode assembly 10 may be disposed between the terrace parts 23 and 26 of the pair of cases 20a and 20b. For example, the insulating part 14 may be disposed between the first terrace parts 23 of the pair of cases 20a and 20b.

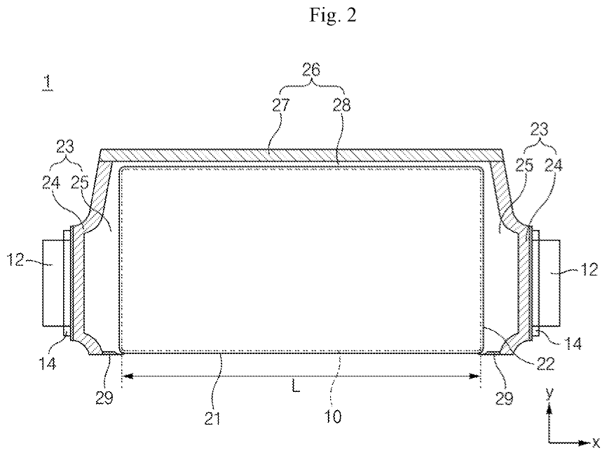

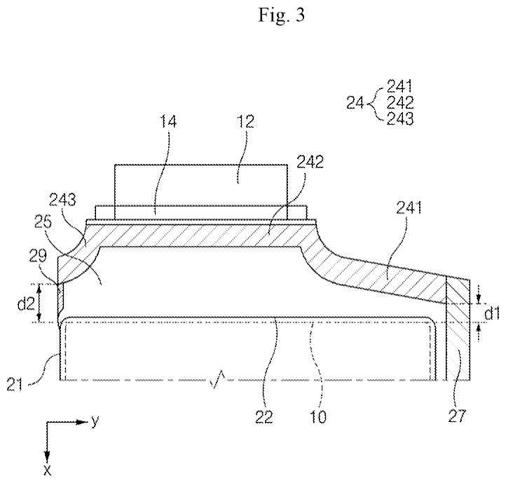

FIG. 2 is a plan view of the pouch-type secondary battery according to an embodiment of the disclosure, and FIG. 3 is a partial enlarged plan view of a pouch-type secondary battery according of FIG. 2.

The battery case 20 may include a pair of first sealing parts 24 disposed at both sides of the cup part 22 in the length direction and a second sealing part 27 connecting the pair of first sealing parts 24 to each other and disposed at one side of the cup part 22 in the width direction, opposite the folding part 21.

The sealing parts 24 and 27 may be portions of terrace parts 23 and 26 that are sealed to each other when the first case 20a and the second case 20b are in contact with each other. In more detail, the first sealing part 24 may be provided by sealing outer portions of the first terrace parts 23 of the pair of cases 20a and 20b to each other. Similarly, the second sealing part 27 may be provided by sealing outer portions of the second terrace parts 26 of the pair of cases 20a and 20b to each other.

Each first sealing part 24 may connect the folding part 21 to the second sealing part 27. Thus, the battery case 20 may be sealed by the pair of first sealing parts 24 and second sealing parts 27.

A dimension (e.g., the width) of each of the first sealing part 24 and the second sealing part 27 may be substantially constant, but the present disclosure is not limited thereto.

With additional reference to FIG. 3, the first sealing part 24 may include a first section 241, a second section 242, and a third section 243.

The first section 241 may be extend between the second sealing part 27 and the second section 242. A distance between the first section 241 and the cup part 22 may increase along the length of the first section 241 in a direction from the second sealing part 27 toward the second section 242. That is, the first section 241 may extend in an oblique or curved direction with respect to the width direction of the cup part 22.

The second section 242 may extend between the first section 241 and the third section 243 and the electrode lead 12 may protrude through the second section 242. In more detail, an insulating part 14 that insulates the electrode lead 12 may be disposed between the second sections 242 of the first sealing parts 24 of the pair of cases 20a and 20b. A distance between the second section 242 and the cup part 22 may be constant over the length of the second section 242. That is, the second section 242 may extend parallel to the width direction of the cup part 22.

The third section 243 may extend between the second section 242 and the folding part 21. A distance between the third section 243 and the cup part 22 increases along the length of the third section 243 and in a direction from the folding part 21 toward the second section 242. That is, the third section 243 may extend in an oblique or curved direction with respect to the width direction of the cup part 22.

A dimension of the first section 241 may be greater than that of the third section 243. A dimension of the second section 242 may be greater than that of the third section 243.

In the length direction of the cup part 22, a minimum distance d1 between the first section 241 and the electrode assembly 10 may be less than a minimum distance d2 between the third section 243 and the electrode assembly 10.

Due to the configuration of the first sealing part 24, a space in the battery module (not shown) in which a plurality of pouch-type secondary batteries 1 is accommodated may be efficiently utilized.

The second sealing part 27 may be folded at least once toward the cup part 21. For example, the second sealing part 27 may be double side folded (DSF). As a result, an energy density of the pouch-type secondary battery 1 may increase.

The battery case 20 may further include a gas pocket part 25 disposed between the cup part 22 and the first sealing part 24.

The gas pocket part 25 may include inner portions on the first terrace parts 23 of the pair of cases 20a and 20b that are not sealed to each other. In this regard, the inside of the gas pocket part 25 communicates with the accommodation space of the cup part 22, allowing gas generated in the electrode assembly 10 to be accommodated in the gas pocket part 25 as well as the cup part 22.

The battery case 20 may further include a non-sealed part 28 disposed between the cup part 22 and the second sealing part 27.

The non-sealed part 28 may be inner parts of the second terrace parts 26 of the pair of cases 20a and 20b that are not sealed to each other. Due to the non-sealed part 28, it is possible to prevent a high-temperature sealing tool, used to form the second sealing part 27, from being contacting the cup part 22 and affecting the electrode assembly 10.

The non-sealed part 28 may also be in communication with the gas pocket part 25 such that gas generated in the electrode assembly 10 may be accommodated in the non-sealed part 28 and travel to the gas pocket part 25. Since a width of the non-sealed part 28 is narrower than the gas pocket part 25, the amount of gas capable of being accommodated by the non-sealed part 28, alone, may be insufficient.

The battery case 20 may further include a sub-sealing part 29 connected to the first sealing part 24. The sub-sealing part 29 may be formed by sealing a partial outer portion of the folding part 21. In more detail, the sub-sealing part 29 may be formed by sealing a portion of the folding part 21, which is disposed on first terrace parts 23 of the pair of cases 20a and 20b between the third section 243 and the cup part 22. The sub-sealing part 29 may extend approximately parallel to the length direction of the cup part 22 and have a predetermined interval with respect to the cup part 22.

Overall sealing strength of the battery case 20 may be further improved by the sub-sealing part 29.

As the demand for high-capacity batteries, such as batteries for electric vehicles increases, the size and weight of the electrode assembly has increased to meet the high-capacity demand. However, when an external impact occurs, such as when the electric vehicles crashes, the pouch-type battery case 20 housing the larger sized and heavier weighted electrode assemblies is more susceptible to damage. Put differently, the larger and heavier electrode assembly may penetrate the pouch-type battery case when the electrode assembly is forcibly displaced into the battery case. If the pouch-type battery case is damaged, the electrolyte may leak, or the electrode assembly may be deformed resulting in a fire, an explosion, or other serious limitations in battery performance and safety.

To alleviate the concern, in which the electrode assembly 10 is displaced from its original position to forcibly contact and damage/penetrate the battery case 20, the pouch-type secondary battery 1 according to the present disclosure may be formed such that a ratio of an area of the first sealing part 24 compared to a weight of the electrode assembly 10 satisfies a specific condition.

In more detail, when the area of the first sealing part 24 is A mm2, and the weight of the electrode assembly 10 is B g, a ratio A/B may be greater than or equal to about 0.29. That is, the area (mm2) of each first sealing part 24 may be greater about 0.29 times than the weight g of the electrode assembly 10.

Since inertia increases as the weight of the electrode assembly 10 increases, there is a high risk that a heavier electrode assembly 10 may damage battery case 20 when an external impact is applied.

In addition, the stress applied to battery case 20 may vary depending on a direction in which the external impact is applied. Put differently, since each first sealing part 24 has a length less than that of the second sealing part 27, when the external impact is applied from the electrode assembly 10 to the first sealing part 24, the stress applied to battery case 20 may be greater compared to when the same force is applied to the second sealing part 27. As a result, the risk of damage or penetration of the first sealing part 24 is greater than that of the second sealing part 27.

Therefore, to improve impact resistance, the area of the first sealing part 24 should be increased to counteract stresses applied to the battery case 20 by the heavier electrode assemblies 10.

More specifically, if the area (mm2) of the first sealing part 24 is less about 0.29 times the weight g of the electrode assembly 10, when an external impact is applied to the pouch-type secondary battery 1, there is a risk that the battery case 20 may be damaged by the electrode assembly 10 or that the electrode assembly 10 may penetrate the battery case 20.

In addition, when the area of the first sealing part 24 is excessively increased, energy density of the pouch-type secondary battery 1 may be decreased. Accordingly, the area (mm2) of the first sealing part 24 may be less about 0.37 times the weight g of the electrode assembly 10, thereby providing improved safety without sacrificing performance of the secondary battery 1. That is, the ratio A/B may be in the range of about 0.29 to about 0.37.

Again, if the area (mm2) of the first sealing part 24 is greater than about 0.37 times the weight g of the electrode assembly 10, the energy density of the pouch-type secondary battery may be too low. In addition, when the size of the pouch-type secondary battery 1 increases, it may be difficult to accommodate a plurality of larger pouch-type secondary batteries in a battery module (not shown).

Hereinafter, additional features of the pouch-type secondary battery 1 will be described with reference to FIGS. 1 to 3.

The pouch-type secondary battery 1 may also minimize the force, and in turn, the damage or penetration, that occurs when the electrode assembly 10 is displaced from its original position due to an external impact. Specifically, such result occurs when a ratio of a minimum distance d1 between the first sealing part 24 and the electrode assembly 10 in a length direction of a cup part 22, relative to a length L of the electrode assembly 10, satisfies a specific condition.

In more detail, in the pouch-type secondary battery 1, the minimum distance d1 (hereinafter, referred to as “a clearance distance”) between the first sealing part 24 and the electrode assembly 10 in the length direction of the cup part 22 may be about 0.5% or more compared to the length L of the electrode assembly 10.

As described above, since the minimum distance d1 between a first section 241 and the electrode assembly 10 in the length direction of the cup part 22 is less than a minimum distance d2 between a third section 243 and the electrode assembly 10, the clearance distance d1 may mean a minimum distance between the first section 241 of the first sealing part 24 and the electrode assembly 10.

When the length L of the electrode assembly 10 increases, the battery case 20 may be susceptible to damage if an external impact is applied and the electrode assembly 10 is forcibly displaced against an inner surface of the battery case.

However, since the clearance distance d1 is a distance by which the electrode assembly 10 may be displaced from its original position before the electrode assembly 10 contacts the first sealing part, the risk that electrode assembly 10 will damage and/or penetrate the first sealing part decreases, as the clearance distance increases.

Therefore, to realize excellent impact resistance, the clearance distance d1 should increase as the length L of the electrode assembly 10 increases.

If the clearance distance d1 is less than about 0.5% of a total length L of the electrode assembly 10, when an external impact is applied to the pouch-type secondary battery 1, the electrode assembly 10 may damage the battery case 20 or penetrate the battery case 20.

In addition, to prevent the energy density of the pouch-type secondary battery 1 from being lowered due to an excessive increase in clearance distance d1, the clearance distance d1 may be about 0.8% or less of the total length L of the electrode assembly 10. That is, the clearance distance d1 may be about 0.5% to about 0.8% of the total length L of the electrode assembly 10. Consequently, safety of the secondary battery 1 may be improved without sacrificing performance of the secondary battery 1.

If the clearance distance d1 is greater than about 0.8% of the total length L of the electrode assembly 10, the energy density of the pouch type secondary battery 1 may be too low. In addition, when the size of the pouch-type secondary battery 1 increases, it may be difficult to accommodate a plurality of larger pouch-type secondary batteries in a battery module (not shown).

The ratio condition of the area of the first sealing part to the weight of the electrode assembly 10, and a ratio condition of the clearance distance d and the length L of the electrode assembly 10 may be alternatives or the pouch-type secondary battery 1 may simultaneously satisfy both the conditions. In addition, the above-described shape of the first sealing part 24, and specifically, the structure of the first section 241, the second section 242, and the third section 243 may contribute to the aforementioned ratios.

Thus, when an external impact is applied, the risk of damage or penetration of the first sealing part may be reduced, and separation of the electrode assembly and/or the leakage of the electrolyte may be suppressed to realize excellent impact resistance.

In addition, the effects that are obvious to those skilled in the art may be predicted from the configurations according to the embodiment of the present invention.

The above-disclosed subject matter is to be considered illustrative, and not restrictive, and the appended claims are intended to cover all such modifications, enhancements, and other embodiments, which fall within the true spirit and scope of the present disclosure.

Thus, the embodiment of the present invention is to be considered illustrative, and not restrictive, and the technical spirit of the present invention is not limited to the foregoing embodiment.

Therefore, the scope of the present disclosure is defined not by the detailed description of the invention but by the appended claims, and all differences within the scope will be construed as being included in the present disclosure.

What is claimed is:

1. A pouch-type secondary battery, comprising:
an electrode assembly; and
a pouch-type battery case comprising:
a cup part configured to accommodate the electrode assembly, the cup part extending in a length direction and in a width direction perpendicular thereto;
a pair of first sealing parts disposed at both sides of the cup part perpendicular to the length direction; and
a second sealing part connecting the pair of first sealing parts to each other and disposed at least on one side of the cup part perpendicular to the width direction,
wherein, the electrode assembly and the pouch-type battery case are formed such that a ratio A/B is 0.29 or more, when A is an area of one of the first sealing parts and measured in mm2, and B is a weight of the electrode assembly measuring in g.

2. The pouch-type secondary battery of claim 1, wherein the ratio A/B is about 0.37 or less.

3. The pouch-type secondary battery of claim 1, wherein the pouch-type battery case further comprises a gas pocket part disposed between the cup part and at least one of the pair of first sealing parts, wherein the gas pocket part is configured to contain a gas discharged from the electrode assembly.

4. The pouch-type secondary battery of claim 1, wherein a minimum distance between the first sealing part and the electrode assembly in the length direction of the cup part ranges between about 0.5% and about 0.8% compared to a length of the electrode assembly.

5. The pouch-type secondary battery of claim 1, wherein the first sealing part comprises:
a first section having a first end connected to the second sealing part and a second end, and a distance between the first section and the cup part in the length direction of the cup part increases from the first end to the second end; and
a second section connected to the first section and from which an electrode lead connected to the electrode assembly protrudes.

6. The pouch-type secondary battery of claim 5, wherein a minimum distance between the first section and the electrode assembly in the length direction of the cup part ranges between about 0.5% and about 0.8% of a length of the electrode assembly.

7. The pouch-type secondary battery of claim 5, wherein the pouch-type battery case further comprises a folding part disposed at an opposite side of the second sealing part with respect to the cup part and connects the pair of first sealing parts to each other, and
each of the first sealing parts further comprises a third section having an end connected to the second section and an opposite end connected to the folding part, and a distance between the third section and the cup part in the length direction of the cup part increases from the opposite end connected to the folding part to the end connected to the second section.

8. The pouch-type secondary battery of claim 7, wherein a minimum distance between the first section and the electrode assembly in the length direction of the cup part is less than a minimum distance between the third section and the electrode assembly.

9. The pouch-type secondary battery of claim 7, wherein the first section has a length greater than a length of the third section.

10. A pouch-type secondary battery, comprising:
an electrode assembly; and
a pouch-type battery case comprising:
a cup part configured to accommodate the electrode assembly, the cup part extending in a length direction and a width direction perpendicular thereto;
a pair of first sealing parts disposed at both sides of the cup part perpendicular to the length direction; and
a second sealing part connecting the pair of first sealing parts to each other and disposed at least on one side of the cup part width direction,
wherein a minimum distance between the first sealing part and the electrode assembly in the length direction of the cup part is about 0.5% or more compared to a length of the electrode assembly.

11. The pouch-type secondary battery of claim 10, wherein the minimum distance between the first sealing part and the electrode assembly in the length direction of the cup part is about 0.8% or less compared to a length of the electrode assembly.

12. The pouch-type secondary battery of claim 10, wherein the electrode assembly and the pouch-type battery case are formed such that a ratio A/B is between about 0.29 and about 0.37, when A is an area of one of the first sealing parts and is measured in mm2, and B is a weight of the electrode assembly and is measured in g.

13. The pouch-type secondary battery of claim 10, wherein the pouch-type battery case further comprises a gas pocket part disposed between the cup part and at least one of the pair of first sealing parts.

14. A secondary battery for reducing greenhouse gas emissions, comprising:
an electrode assembly; and
a pouch-type battery case comprising:
a cup part configured to accommodate the electrode assembly;
a pair of first sealing parts disposed at both sides of the cup part in a length direction, respectively; and
a second sealing part connecting the pair of first sealing parts to each other and disposed at least on one side of the cup part in a width direction; and
a gas pocket part disposed between the cup part and at least one of the pair of first sealing parts,
wherein, the first sealing part includes a first section defining an obliquely curved length between the second sealing part and a second section.

15. The secondary battery of claim 14, wherein the pouch-type battery case further comprises a folding part disposed at an opposite side of the second sealing part with respect to the cup part, the folding part connecting the pair of first sealing parts to each other.

16. The secondary battery of claim 15, wherein the first sealing part further comprises a third section defining an obliquely curved length between the folding part and the second section.

17. The secondary battery of claim 16, wherein, when an area of the first sealing part is A mm2, and a weight of the electrode assembly is B g, a ratio A/B is between about 0.29 and about 0.37.

18. The secondary battery of claim 16, wherein the pouch-type battery case further comprises a sub-sealing part disposed on or adjacent to the folding part and between the third section and the cup part.

19. The secondary battery of claim 16, wherein a minimum distance between the first section of the first sealing part and the electrode assembly in the length direction of the cup part is between about 0.5% and about 0.8% compared to a length of the electrode assembly.

20. The secondary battery of claim 19, wherein the minimum distance is a distance between the cup part and an end of the first section of the first sealing part connected to the second sealing part.
